(19) United States
(12) Patent Application Publication
(10) Pub. No.: US 2016/0054946 A1
(43) Pub. Date: Feb. 25, 2016

(54) SYSTEM AND METHOD FOR MANAGING LOGICAL VOLUMES

(71) Applicant: HITACHI, LTD., Tokyo (JP)

(72) Inventors: Pablo Martinez Lerin, Tokyo (JP); Jun Nakajima, Tokyo (JP); Hironori Emaru, Tokyo (JP); Yukinori Sakashita, Tokyo (JP)

(73) Assignee: HITACHI, LTD., Tokyo (JP)

(21) Appl. No.: 14/784,946

(22) PCT Filed: Feb. 18, 2014
(86) PCT No.: PCT/JP2014/000829

§ 371 Date: Oct. 15, 2015

(51) Int. Cl. G06F 3/06

(52) U.S. Cl. CPC G06F 3/0634; G06F 3/0619; G06F 3/0685

(57) ABSTRACT

A management system manages a plurality of logical volumes in a storage system coupled to a host system. The plurality of logical volumes includes a first logical volume provided to the host system and a second logical volume. The management system manages the second logical volume as a duplicate of the first logical volume and a first state volume which is provided to the host system. The management system changes the second logical volume to a second state volume associated with the first logical volume, which is not a logical volume provided to the host system and which is on standby for a future use by the host system. The management system manages a data difference between data stored in the second logical volume and data stored in the first logical volume associated with the second logical volume if data is newly stored in the first logical volume.

### TECHNICAL FIELD

The present invention generally relates to management of logical volumes.

### BACKGROUND ART

Recently, a data center dynamically allocates its computers, networks and storage virtualized resources in order to make efficient use of resources and solve or mitigate bottlenecks and failures quickly. In particular, volume scale out is performed to satisfy an expected or unexpected increase on the read-workload demand of a service, that cannot be satisfied with a single logical volume. Moreover, volume migration is performed to satisfy an expected or unexpected increase on the disk-performance demand (e.g. require changing from SATA to SSD), and to balance the workload of several storages. Migration may also be required to resume the service when a problem occurs in the I/O path between a host and its provided logical volume. However, performing volume scale out and volume migration takes a big amount of time because full data copy is required.

On the other hand, there is a data reusing method in order to avoid copying large amounts of data between logical volumes. Patent Literature 1 discloses a system in which even with the command to delete the application data, the stored application data is not deleted but it is kept stored for future reuse by the same application. This method avoids the time-consuming task of making a backup and restoring the application data that needs to be reused.

### CITATION LIST

### Patent Literature

[PTL 1]

US Patent Publication No. 2012/0179823

### SUMMARY OF INVENTION

### Technical Problem

The related art disclosed by Patent Literature 1 is used for the purpose of reusing data as a copy of previously discarded data. However, this technology cannot be used for logical volume scale out or migration. Because in these cases, at least one logical volume is still provided to the host. Therefore, for reusing the data once duplicated to the original data, management of relationship between the original data is required. For example, when a logical volume is migrated to a new logical volume, the original volume is usually deleted. Even if the data in the source logical volume is not deleted but kept, it cannot be used as a copy of the data in the destination logical volume, which is provided to a host, because in the system of the Patent Literature 1 (1) data kept is not associated with original data but with an application, and (2) data kept is not updated according to the changes in related original data. As a result, it is not possible to reuse the data kept in order to avoid the time-consuming and resource-consuming task of copying a logical volume when performing management operations such as at least one of logical volume scale out and logical volume migration, which are operations that need to be performed in short time to solve unexpected problems and demands before downtime and bad performance occur.

### Solution to Problem

A management system manages a plurality of logical volumes in a storage system coupled to a host system. The plurality of logical volumes includes a first logical volume provided to the host system and a second logical volume. The management system manages the second logical volume as a duplicate volume of the first logical volume and a first state volume which is a logical volume provided to the host system. The management system changes the second logical volume to a second state volume associated with the first logical volume, which is not a logical volume provided to the host system and which is on standby for a future use by the host system. The management system manages a data difference between data stored in the second logical volume which is the second state volume and data stored in the first logical volume associated with the second logical volume if data is newly stored in the first logical volume.

### Advantageous Effects of Invention

According to the present invention, in a data center, an automated process or an administrator can perform unplanned management operations such as at least one of scale out and migration without the need for time-consuming logical volume copy.

### BRIEF DESCRIPTION OF DRAWINGS

FIG. 1 is a diagram showing the evolution through time of host-logical volume association and logical volume state in a storage system, reacting to performed management operations according to an embodiment of the present invention.

FIG. 2 is a diagram showing a schematic configuration of a computer system according to the embodiment.

FIG. 3 shows a configuration example of a logical volume association table provided in the management computer.

FIG. 4 shows a configuration example of a logical volume pairing table provided in the management computer.

FIG. 5 shows a configuration example of a logical volume management table provided in the management computer.

FIG. 6 shows a configuration example of a storage management table provided in the management computer.

FIG. 7 shows a flow chart for explaining processing performed by the management computer at the time when a logical volume duplication request arrives.

FIG. 8 shows a flow chart for explaining processing performed by the management computer at the time when a logical volume deletion request arrives.

FIG. 9 shows a flow chart for explaining processing performed by the management computer, for example periodically at small time intervals.

### DESCRIPTION OF EMBODIMENTS

An embodiment of the present invention will be described below.

Although the expression “aaa table” is used to describe information in the following description, the information may be expressed in a data structure other than a table. In order to denote independence from the data structure, the term “aaa table” can be replaced with the term “aaa information”.

Although an ID (identifier) is used as information for identifying a target in the following description, the ID can be replaced with other kinds of identification information.

In the following description, the term “program” is occasionally used as a subjective to describe a process. However, the program is executed by a processor unit (for example, a CPU (Central Processing Unit)) to perform a determined process using at least one of a storage unit (e.g. a memory) and an interface unit (e.g. a communication port). Therefore, the subject of the process can be a processor unit. A part of the process may be performed by a hardware circuit, and the processor unit may comprise the hardware circuit. A program may be installed from a program source. The program source may be a program distribution server or a portable storage medium, for example.

In the following description, a collection of one or more computers configured to manage logical volumes and display information for display may be referred to as a “management system”. In the case where a management computer displays the information for display, the management computer may serve as the management system. In addition, a combination of the management computer and a display computer also may serve as the management system. In order to enhance the speed and the reliability of a management process, a plurality of computers may be used to achieve a process that is identical or similar to that performed by the management computer. In this case, the plurality of computers (which may include the display computer in the case where the display computer is used for display) may serve as the management system. In the embodiment, the management computer serves as the management system. The phrase “the management computer displays information” may denote that information is displayed on a display device possessed by the management computer, or may denote that information for display is transmitted to the display computer coupled to the management computer. In the latter case, the display computer displays information represented by the information for display on the display device possessed by the display computer.

In the following description, the term “logical volume” denotes a logical storage device. The logical volume may be a real logical volume, or may be a virtual logical volume. The term “real logical volume” denotes a logical volume based on one or more PDEVs. The term “PDEV” is the abbreviation of a non-volatile physical storage device such as a HDD (Hard Disk Drive) or a SSD (Solid State Drive). A plurality of PDEVs may form a plurality of RAID (Redundant Array of Independent (or Inexpensive) Disks) groups. The RAID group may be referred to as a “parity group”. Examples of the “virtual logical volume” may include a logical volume according to a storage virtualization technology and that is based on a storage resource (e.g. a logical volume) of an external storage apparatus coupled to a storage apparatus having the virtual logical volume, a logical volume according to a capacity virtualization technology (typically, Thin Provisioning), and a logical volume provided as a snapshot of an original logical volume.

<Overview of the Embodiment>

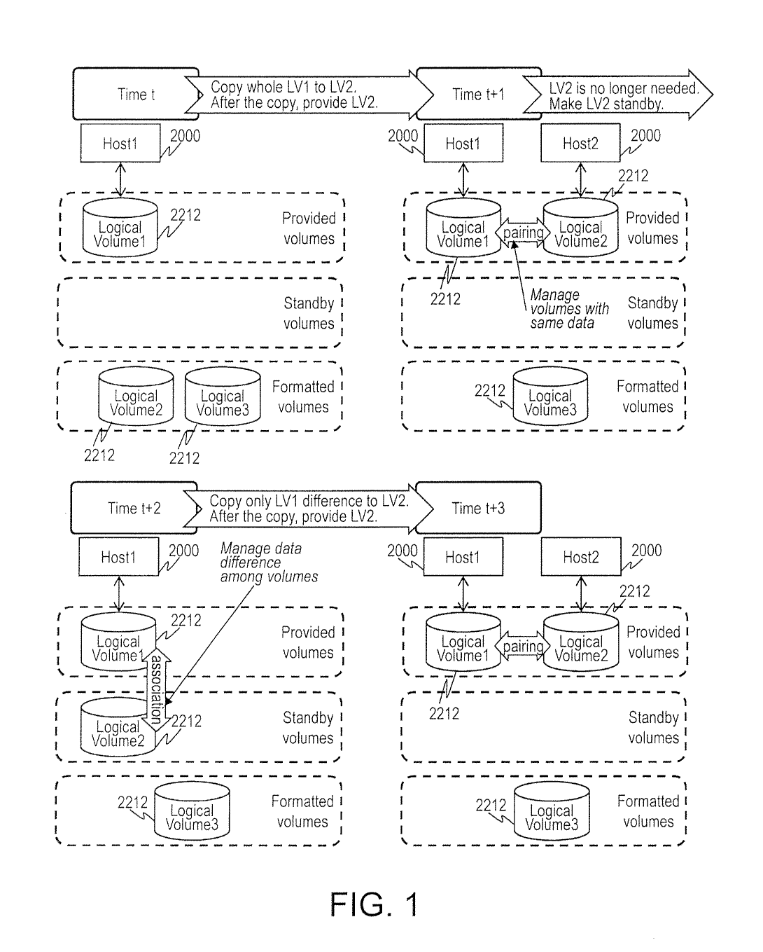

An overview of the embodiment is explained by referring to the diagram shown in FIG. 1.

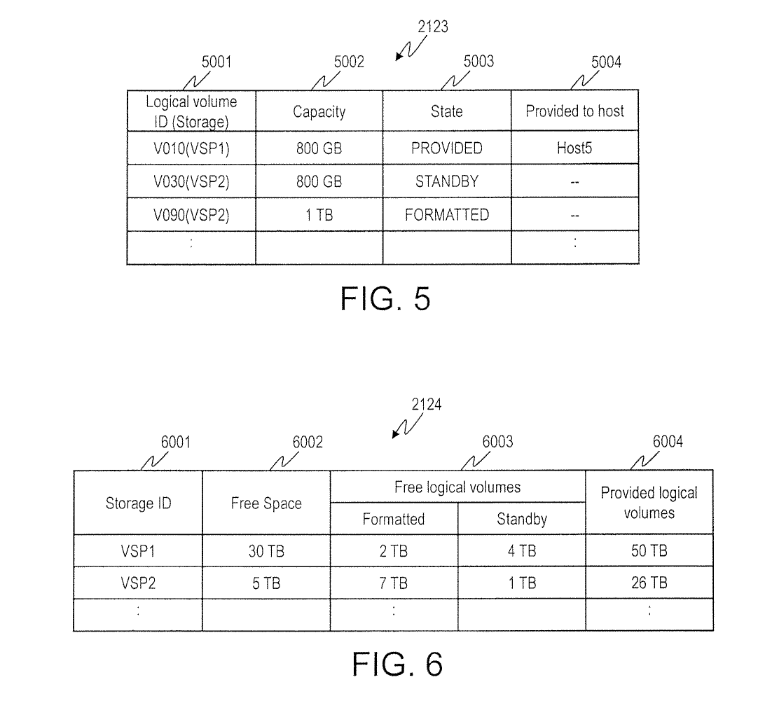

FIG. 1 shows the state of the logical volumes 2212 in a storage system at four different instants of times. The instants of times are (t), (t+1), (t+2) and (t+3), from earlier to later. Each instant of time occurs after an arbitrary period of time has passed since the previous instant of time. A logical volume has one of three states managed by the management computer (FIG. 5). The three states are “Provided”, “Standby” and “Formatted”. A Formatted logical volume is a logical volume with no data and not provided to a host system such as a host computer 2000 coupled to the storage system. In other words, the Formatted logical volume are not managed by the host computer and can't be recognized by the host computer. (the host system includes two host computers named Host1 and Host2 in an example according to FIG. 1). A Formatted logical volume can be a logical volume which is formatted. A Standby logical volume is a logical volume with data and not provided to the host system. A Standby logical volume is on standby for a future use by the host system. A Provided logical volume is a logical volume with data and provided to the host computer 2000, i.e. the host computer 2000 can have read access and/or write access to the data in the Provided logical volume.

Time (t) represents a host computer named Host1 that serves a service. The Provided logical volume named Logical volume1, hereinafter LV1, is coupled to Host1 (FIG. 5). Two logical volumes named LV2 and LV3 remain formatted.

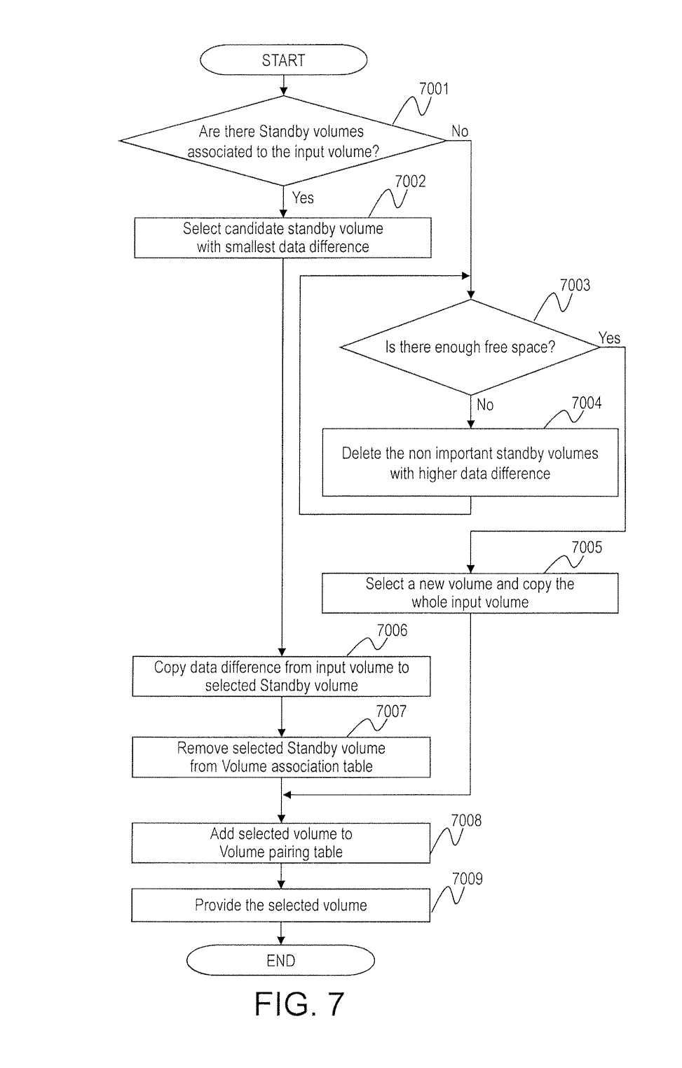

After time (t), the service served by Host1 has a temporal demand for read-heavy workload that LV1 alone cannot satisfy. Therefore, scale out is requested. Since LV1 is not associated with any Standby logical volume, scale out is performed as follows (FIG. 7), (1) copying the whole data stored in logical volume LV1 to LV2 by the storage system in response to a request from the management system, and, (2) after the copy, providing LV2 to another host computer named Host2 by the storage system autonomously or in response to a request from the management system (LV2 can be provided to Host1 instead of Host2). As a result, the demand is satisfied after the logical volume is copied, which depending on the size of the logical volume may take a considerably long time. Moreover, copying LV1 to LV2 may affect negatively the performance of LV1 when LV1 is most needed.

Time (t+1) represents the state when the scale out task has finished and LV2 is a Provided logical volume, coupled to Host2. The read-heavy workload of the service is divided or balanced between Host1 and Host2. The data in LV1 and LV2 is kept the same by propagating the changes (write) that arrive to one of the logical volumes to the other logical volume. The changes can be propagated by at least one of the storage system, the host system and the management system. The logical volumes LV1 and LV2 are considered in a pairing relation because their data is kept synched by the storage system. The recent read and write rate of LV1 is managed by the management system. The read and write rate is a value, expressed as read frequency (e.g. TOPS (I/O per second)) divided by read and write frequencies. Further the storage system can manage a paring relation between LV1 and LV2 and keep their data synched.

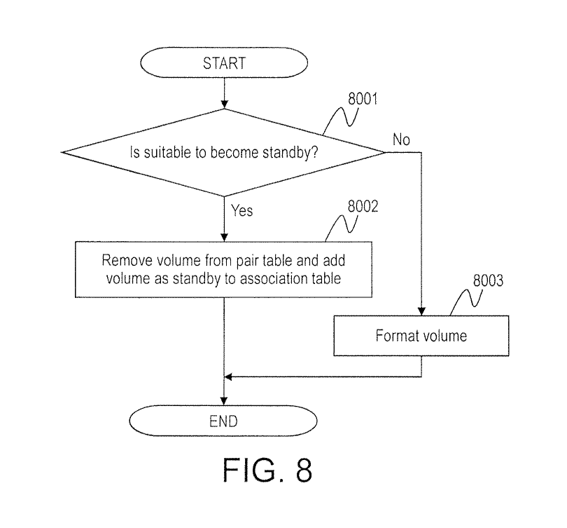

After time (t+1), the service demand for read-heavy workload ends. In order to use efficiently the storage system resources, Host2 is released from the service, and the resources to couple Host2 and LV2 are released. The management system determines that LV2 is suitable to become a Standby logical volume, based on the recent read and write rate of LV1, which denotes that the service has read-heavy workload and does not have write-heavy workload (FIG. 8). Also, the management system can a request, to the storage system, to change status of LV2 from Provided to Standby. In response to the request, the storage system can manage LV2 as a Standby logical volume.

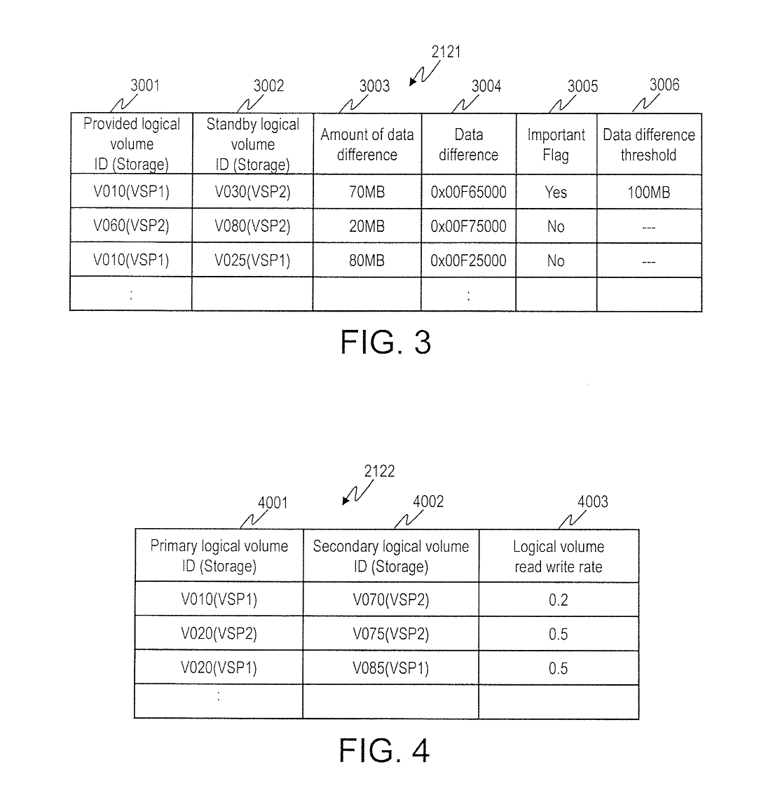

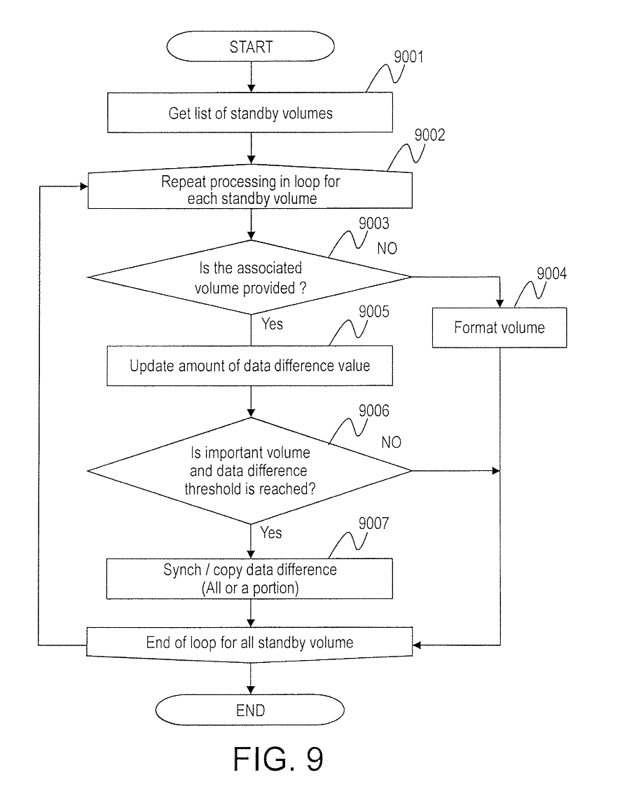

When LV2 becomes a Standby logical volume, LV2 contains the same data as LV1, but their data becomes different as writes arrive to LV1. The association between LV1 and LV2 and the data difference are managed by at least one of the management system and the storage system (FIG. 3). When a condition is reached, the data that is different can be copied from LV1 to LV2, in order to synch LV1 and LV2 fully or partially (FIG. 9), by the storage system autonomously or in response to a request from the management system. When the computer system runs out of free space or Formatted logical volumes, the Standby logical volume LV2 is deleted or formatted (FIG. 7).

Time (t+2) represents the state when the LV1 and LV2 are associated and their data difference is managed by at least one of the management system and the storage system. LV1 is a Provided logical volume and LV2 is a Standby logical volume. In time (t+2), if the amount of the data difference is above a threshold, the managed data difference can be copied from LV1 to LV2 fully or partially by the storage system autonomously or in response to a request from the management system, so that the amount is smaller than the threshold. As a result, it is possible to synch LV1 and LV2 after time (t+2).

After time (t+2), the service served by Host1 has again a temporal demand for read-heavy workload that LV1 alone cannot satisfy. Therefore, scale out is requested. Since LV1 is associated with a Standby logical volume, scale out is performed in short time as follows (FIG. 7), (1) copying the managed data difference from LV1 to LV2, in order to synch LV1 and LV2 fully, and, (2) after the copy, providing LV2 to a host named Host2. As a result, the demand is satisfied considerably sooner after copying a small portion of data or any. When LV1 is associated with several Standby logical volumes, the most suitable volume to be provided is selected as the Standby logical volume with the smallest data difference with LV1.

Time (t+3) represents the state when the scale out task has finished, similarly to the state represented in time (t+1).

As described in the overview above, by (1) keeping the logical volume that was requested to be deleted, (2) associating the logical volume kept with its original logical volume provided to a host, and (3) managing the data difference between the logical volumes, one duplicated logical volume of the original logical volume can be provided multiple times by performing a full copy of a logical volume for the first time it is duplicated. Moreover, because the management system according to the embodiment handles the burden of deciding which logical volumes are kept, for how long are kept, and when should be reused or deleted, the management system can be also used by automated processes such as auto-scale and migration, and by unskilled users and administrators that request operations of logical volume duplication and logical volume deletion.

<Configuration of a Computer System>

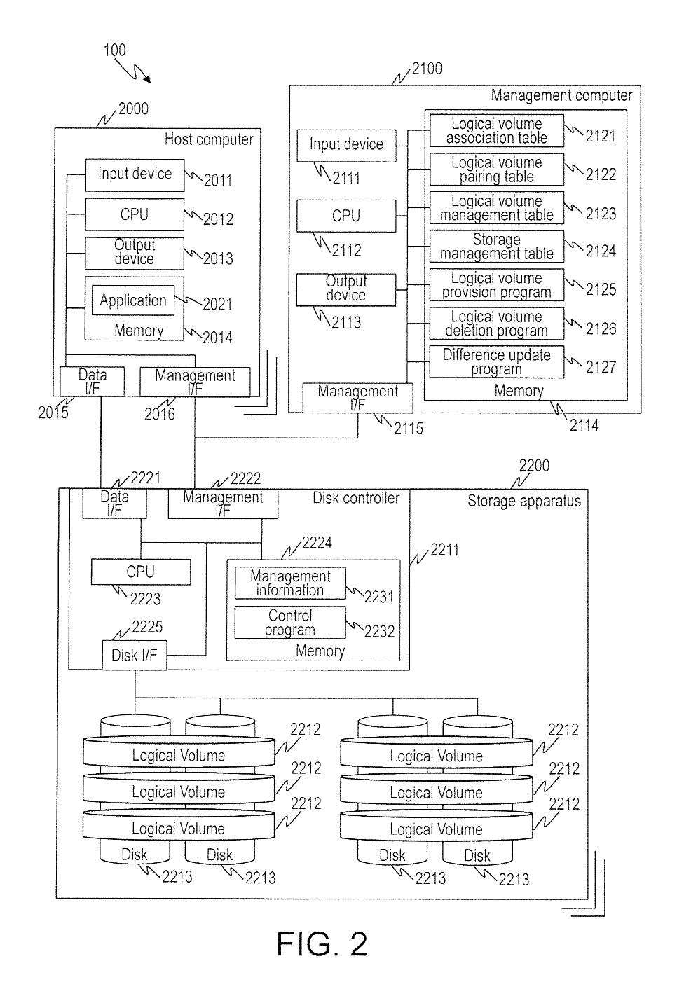

FIG. 2 is a diagram showing a schematic configuration of a computer system according to the embodiment of the present invention.

A computer system 100 includes a storage system and a host system coupled to the storage system via a network such as SAN (Storage Area Network). A management system managing a plurality of logical volumes 2212 is coupled to the storage system and the host system via the same or another network such as a LAN (Local Area Network).

The host system is at least one host computer 2000. The host computer 2000 is a computer which uses a logical volume 2212 provided by a storage apparatus 2200, specifically, the host computer 2000 issues an I/O (Input/Output) request designating the logical volume 2212 to the storage apparatus 2200. The host computer 200 comprises an interface unit, a storage unit, an input unit, an output unit and a processor unit coupled to them. The interface unit is at least one interface device such as a data I/F 2015 and a management I/F 2016. The data I/F 2015 (e.g. an interface device of SAN) is coupled to the storage system. The management I/F 2016 (e.g. an interface device of LAN) is coupled to the management system. The data I/F 2015 and the management I/F 2016 may be the same. The storage unit is at least one storage device such as a memory 2014. The input unit is at least one input device 2011 such as a keyboard, a pointing device and so on. The output unit is at least one output device 2013 such as a display device. The processor unit is at least one processor such as a CPU 2012. The memory 2014 stores a program such as an application 2021, and the CPU 2012 executes the application 2021. The application 2021 includes a program for using a provided logical volume.

The storage system is at least one storage apparatus 2200. The storage apparatus 2200 comprises a plurality of disk devices 2213 and a storage controller unit coupled to the plurality of disk devices 2213.

Each disk device 2213 is an example of a PDEV. The plurality of disk devices 2213 may be at least one RAID group. The plurality of logical volumes 2212 are based on the plurality of disk devices 2213.

The storage controller unit is at least one storage controller such as a disk controller 2211. The disk controller 2211 comprises an interface unit, a storage unit such as a memory 2244, and a processor unit such as a CPU 2223 coupled to the interface unit and the storage unit. The interface unit comprises a data I/F 2211 coupled to the host system, a management I/F 2222 coupled to the management system, and a disk I/F 2215 coupled to the plurality of disk devices 2213. The memory 2224 stores management information 2231 a control program 2232. The management information 2231 is information with respect to the plurality of logical volumes 2212. The management information 2231 may include the same tables as tables 2121 to 2124. The CPU 2223 executes the control program 2232. The disk controller 2211 receives an I/O request designating a logical volume 2212, and write/read data in/from disk devices 2213 which are the basis of the logical volume. The disk controller 2211 manages data difference between data stored in a first logical volume and data stored in a second logical volume which has a certain relationship with the first logical volume. In the embodiment, the first logical volume is a Provided logical volume such as a Primary logical volume (a copy source logical volume) having a pairing relation with a Secondary logical volume (a copy target logical volume), or a logical volume not forming a copy pair but associated with a Standby logical volume. The second logical volume is a Secondary logical volume having a pairing relation with a Primary logical volume, a Standby logical volume associated with a Primary logical volume, or a Formatted logical volume The disk controller 2211 is configured to keep the volumes in the same pair (group) same by executing copy data (all data or differential data) from one volume to another volume autonomously or in response to a request from the management system. Further the disk controller 2211 is configured to fully or partially copy data difference between data stored in a Provided logical volume and a Standby logical volume associated with the Provided logical volume autonomously or in response to a request from the management system. Further the disk controller 2211 is configured to input (write) and output (read) of data in and from a logical volume 2212 designated by the I/O request from the host system. Further the disk controller 2211 is configured to configure information in the management information 2231 in response to a request from the management system. Information necessary for these kinds of processing is stored in the management information 2231. For example, the management information 2231 may include information defining volume ID, volume type (e.g. primary, secondary, Provided, or Standby), related volume ID (e.g. paired volume ID or associated Standby logical volume ID) for each logical volume.

As defined above, in the embodiment, the management system is a management computer 2100. The management computer 2100 comprises an interface unit, a storage unit, an input unit, an output unit and a processor unit coupled to them. The interface unit is at least one interface device such as a management I/F 2215. The management I/F 2215 is coupled to the host system and the management system. The storage unit is at least one storage device such as a memory 2114. The input unit is at least one input device 2111 such as a keyboard, a pointing device and so on. The output unit is at least one output device 2113 such as a display device. The processor unit is at least one processor such as a CPU 2112. The memory 2114 stores programs and information. The information is such as (1) a logical volume association table 2121 (FIG. 3) for managing the association among provided logical volumes and standby logical volumes, and their data difference, (2) a logical volume pairing table 2122 (FIG. 4) for managing the relation among provided logical volumes that contain the same data, (3) a logical volume management table 2123 (FIG. 5) for managing the provision of logical volumes to hosts, and the state and capacity of the logical volumes, (4) a storage management table 2124 (FIG. 6) for managing the capacity of the storage apparatuses 2200. The programs are such as (1) a logical volume provision program 2125 (FIG. 7) for providing a logical volume to the host system upon requests, (2) a logical volume deletion program 2126 (FIG. 8) for handling with a logical volume deletion request, and (3) a difference update program 2127 (FIG. 9) for updating the data difference among associated logical volumes. Information stored by the logical volume association table 2121, the logical volume pairing table 2122, the logical volume management table 2123, and the storage management table 2124 is referred to and updated as appropriate by the logical volume provision program 2125, the logical volume deletion program 2126, and the difference update program 2127.

<Logical Volume Association Table 2121>

FIG. 3 shows a configuration example of a Logical volume association table 2121 provided in the management computer 2100. The Logical volume association table 2121 is a table which manages the association among Provided logical volumes and Standby logical volumes, and their data difference, across all the storage apparatuses 2200. The Logical volume association table 2121 has, as configuration information, a Provided logical volume ID 3001 which is information for identifying a logical volume 2212, a Standby logical volume ID 3002 which is information for identifying a logical volume 2212, an amount of data difference 3003 which denotes an amount of data difference between two logical volumes, a data difference 3004 which is a pointer to information (e.g. a bitmap resenting data difference) of the portions of data that are different between two logical volumes, an important flag 3005 which represent whether a Provided logical volume is important or not, and a data difference threshold 3006 indicating the maximum data difference allowed for a Provided logical volume that is important. As for volume IDs, for example, “V010 (VSP1)” denotes a storage apparatus whose storage ID is “VSP1” has a logical volume whose ID is “V010”.

A row of the Logical volume association table 2121 represents an association between a Provided logical volume and a Standby logical volume. A row is added when a logical volume becomes Standby, i.e. when an association is created (FIG. 8). A row is deleted when the Provided logical volume and/or the Standby logical volume change the state or are deleted, i.e. when the association is cancelled (FIG. 7, FIG. 9). A logical volume cannot be Provided and Standby at the same time (FIG. 5). A Provided logical volume is associated with zero, one or multiple Standby logical volumes. When a Provided logical volume is associated with zero Standby logical volumes, the Provided logical volume does not appear in the Logical volume association table 2121. When a Provided logical volume is associated with one or more Standby logical volumes, each association to a Standby logical volume appears in a different row. It can be seen in the Logical volume association table 2121 that the Provided logical volume with ID V010 is associated with two Standby logical volumes: V030 and V025. A Standby logical volume is always associated with one Provided logical volume, and it always appear in one row in the Logical volume association table 2121.

A Standby logical volume can be associated, by the CPU 2212, in the Logical volume association table 2121 with a Provided logical volume which also appears as a Primary logical volume at the Logical volume pairing table 2122 (FIG. 4). It can be seen from the Logical volume association table 2121 that the logical volume with ID “V10” is associated with two Standby logical volumes, and it can be seen from the Logical volume pairing table 2122 (FIG. 4) that at the same time the logical volume V10 is Primary logical volume of a Secondary logical volume with ID “V070”. However, a Standby logical volume cannot be associated, by the CPU 2212, in the Logical volume association table 2121 with a Provided Logical volume which also appears as a Secondary logical volume at the Logical volume pairing table 2122. When a Provided logical volume that appears in the Logical volume association table 2121 and the Logical volume pairing table 2122 changes the role from Primary to Secondary by the CPU 2112, the Logical volume association table 2121 is also changed accordingly by the CPU 2112: the Standby logical volumes is associated with the new Primary logical volume.

A Provided logical volume ID 3001 and a Standby logical volume ID 3002, each identify a logical volume 2212 and the storage apparatus 2200 where the logical volume belongs. Logical volumes 2212 have an ID assigned on creation that never changes until the logical volume is deleted, i.e. becomes free space 6002 (FIG. 6).

The logical volume ID is used in the in the Logical volume association table 2121, the Logical volume pairing table (FIG. 4), and the Logical volume management table (FIG. 5).

An amount of data difference 3003 and a data difference 3004 denote an amount of different data, and the portions of different data, respectively, between the Provided logical volume and the Standby logical volume identified in the same row in the Logical volume association table 2121. Both values are changed by the CPU 2112 (the management computer 2100) (FIG. 9). Since the Standby logical volume has the same data as the Provided logical volume at the time of the association and the Standby logical volume does not change unless explicit request of synch by the CPU 2112, the data that is different can also be expressed as the data that changed in the Provided logical volume since a certain point of time, e.g. since the last synch or since the association was made. The data difference 3004 is a pointer to a place where the information is stored, e.g. in the memory 2224 of the storage apparatus 2200 where the Provided logical volume belongs. The information can be stored for example using the bitmap technology. Several rows of the Logical volume association table 2121 may point to the same information or a combination to make efficient use of memory resources.

An important flag 3005 contains one of two values: “Yes” and “No”. “Yes” value denotes that the logical volume association represented by the same row in the Logical volume association table 2121 is important. “No” value denotes that the mentioned association is not important. This flag is configured when the association is created and may be changed anytime. The flag can be configured automatically by the CPU 2112 (the management computer 2100), for example, in a scenario where the admin configures beforehand a parameter of the maximum performance that a service should be able to reach, and the CPU 2112 decides the number of Standby logical volume associations that should be configured to important in order to be able to quickly satisfy the desired maximum performance.

A data difference threshold 3006 is a value configured in the rows whose association is configured as important by the important flag 3005. When in a row with the important flag 3005 configured to “Yes” the data difference 3004 reaches the data difference threshold 3006, the CPU 2112 determines to synch fully or partially the Provided logical volume and the Standby logical volume by copying data difference specified based on the data difference 3004 from the Provided logical volume to the Standby logical volume (FIG. 9).

It is seen from the Logical volume association table 2121 that a Provided logical volume with ID V010 that belongs to a storage apparatus with ID “VSP1” is associated with a Standby logical volume with ID “V030” that belongs to a storage apparatus with ID “VSP2”, there are 70 MB of different data between the logical volumes, the information of the portions of different data can be accessed with the pointer “0x00F65000”, the association is important, and the data difference threshold is configured to “100 MB”.

<Logical Volume Pairing Table 2122>

FIG. 4 shows a configuration example of a Logical volume pairing table 2122 provided in the management computer 2100. The Logical volume pairing table 2122 is a table which manages the pairing among Provided logical volumes, and their recent read write rate, across all the storage apparatuses 2200. The Logical volume pairing table 2122 has, as configuration information, a Primary logical volume ID 4001 which is information for identifying a logical volume 2212, a Secondary logical volume ID 4002 which is information for identifying a logical volume 2212, and a logical volume read write rate 4003 which denotes the read write rate of a logical volume.

A row of the Logical volume pairing table 2122 represents a pairing relation between a Primary logical volume and a Secondary logical volume, where the Primary logical volume has been copied to the Secondary logical volume and their data is kept synched (FIG. 7), for example by at least one of the storage system, the host system and the management system. A row is added when a copy of a logical volume is made or its associated standby is provided, with the purpose of keeping their data synched (FIG. 7). The logical volumes that appear in the Logical volume pairing table 2122 are Provided logical volumes. A Provided logical volume is a Primary logical volume, a Secondary logical volume, or none of them. When a Provided logical volume is neither a Primary nor a Secondary logical volume, the Provided logical volume does not appear in the Logical volume pairing table 2122. A Primary logical volume is paired to one or more Secondary logical volumes, and each pairing is represented in one row. It can be seen in the Logical volume pairing table 2122 that the Primary logical volume with ID “V001” is associated with two Standby logical volumes V003 and V012. A Secondary logical volume is paired to one Primary logical volume, and appears in one row of the Logical volume pairing table 2122.

A row is deleted when the corresponding pairing relation is cancelled, or when the corresponding Primary logical volume 4001 or Secondary logical volume 4002 is deleted, made Standby or Formatted (FIG. 8). The roles Primary and Secondary are set when the Primary logical volume is copied to the Secondary logical volume, but the roles can be changed anytime. It is strange to delete, make Standby or Format a Primary logical volume while it is paired to one or more Secondary logical volumes. Usually, before deletion the pairing relation is cancelled, the Secondary logical volumes paired to the Primary logical volume are deleted, or the roles are changed.

A Primary logical volume ID 4001 and a Secondary logical volume ID 4002, each identify a logical volume 2212 and the storage apparatus 2200 where the logical volume belongs, similarly as the logical volume ID used in the Logical volume association table 2121 (FIG. 3).

A Logical volume read write rate 4003 contains the recent rate of the Primary logical volume identified in the same row of the Logical volume pairing table 2122. A read write rate is a value from 1 to 0, expressed as read IOPS divided by all IOPS including read and write IOPS. The higher the rate value is, the more read IOs and less write IOs has the logical volume, and therefore a logical volume is more suitable to become Standby by the CPU 2112 (FIG. 8).

It is seen from the Logical volume pairing table 2122 that a Primary logical volume with ID “V010” that belongs to a storage apparatus with ID “VSP1” is associated with a Secondary logical volume with ID “V070” that belongs to a storage apparatus with ID “VSP2”, and the logical volume read write rate is “0.2”.

<Logical Volume Management Table 2123>

FIG. 5 shows a configuration example of a Logical volume management table 2123 provided in the management computer 2100. The Logical volume management table 2123 is a table which manages the logical volumes, and their provision of logical volumes to host computers, across all the storage apparatuses 2200. The Logical volume management table 2123 has, as configuration information, a logical volume ID 5001 which is information for identifying a logical volume 2212, a capacity 5002 which is the total amount of data that can be stored in the logical volume identified based on the ID 5001, a state 5003 which contains one of the three values: “Provided”, “Standby” and “Formatted” and represents the state of the identified logical volume 5001, and a Provided to host 5004 which denotes to which the host computer is provided the logical volume identified based on the ID 5001, if provided.

Each logical volume is represented by one row in the Logical volume management table 2123. Rows are added and deleted when logical volumes are created or deleted, i.e. made free space (FIG. 7). The capacity 5002 changes when the logical volume is resized.

A logical volume with state 5003 “Formatted” is a logical volume with no data and not provided to the host system. A logical volume with state 5003 “Standby” is a logical volume with data and not provided to the host system. A logical volume with state 5003 “Provided” is a logical volume with data and is coupled to the host system. The state of a logical volume is changed by the CPU 2112 (the management computer 2100) (FIG. 7, FIG. 8 and FIG. 9).

A logical volume ID 5001 identifies a logical volume 2212 and the storage apparatus 2200 where the logical volume belongs, similarly as the logical volume ID used in the Logical volume association table 2121 (FIG. 3).

Besides of the configuration example of FIG. 5, the Logical volume association table 2121 can manage different types of disk devices 2213 (e.g. SATA, SSD), and can manage additional information of the logical volume host provision such as the resources used (storage port, switch port, etc.).

It is seen from the Logical volume management table 2123 that a Provided logical volume with ID “V010” that belongs to a storage apparatus with ID “VSP1” has a capacity of “800 GB” and is provided to a host computer named “Host5”.

<Storage Management Table 2124>

FIG. 6 shows a configuration example of a Storage management table 2124 provided in the management computer 2100. The Storage management table 2124 is a table which manages the storage space across all the storage apparatuses 2200. The Storage management table 2124 has, as configuration information, a storage ID 6001 which is information for identifying a storage apparatus 2200, a free space 6002 which denotes the amount of free storage space not assigned to logical volumes in the identified storage apparatus 6001, a free logical volumes 6003 which denotes the amount of free storage space assigned to logical volumes in the identified storage apparatus 6001 and available for any use, a Provided logical volumes 6004 which denotes the amount of storage space assigned to logical volumes and provided to the host system in the identified storage apparatus 6001.

Each storage apparatus 2200 is represented by one row in the Storage management table 2124. The storage space amounts in free space 6002, free logical volumes 6003 and provided logical volumes 6004 change when logical volumes are created (free space is assigned to a logical volume), change state (FIG. 5 5003), and are deleted (made free space).

Besides of the configuration example of FIG. 6, the Storage management table 2124 can manage different types of disk devices 2213 (e.g. SATA, SSD).

It is seen from the Storage management table 2124 that a Storage with ID “VSP1” has 30 TB of free storage space, 2 TB of formatted free storage space, 4 TB of standby free storage space, and 50 TB of provided storage space.

<Logical Volume Provision Processing>

FIG. 7 is a flowchart for explaining processing to answer a request of provisioning a new logical volume that is a copy of a Provided logical volume, for example, for the purpose of performing auto-scale (scale out) or migration (copy original logical volume to a new logical volume). The request may be received from an administrator via the input device 2111. The processing receives as input the Provided logical volume to be copied. The processing is started by an automated process when a condition is reached (e.g. when an auto-scale function is used and the performance gets below a predefined limit). The processing can also be started by an end-user through a provisioning service or an administrator through the management computer 2100.

In 7001, the Logical volume provision program 2125 refers to the Logical volume association table 2121 (FIG. 3) to determine if the input Provided logical volume appears in at least one row in 3001, which means that at least one Standby logical volume is associated with the input Provided logical volume. When no Standby logical volumes are associated (No in 7001), the processing goes to 7003. When at least one Standby logical volume is associated (Yes in 7001), the processing goes to 7006.

In 7002, the Logical volume provision program 2125 refers to the Logical volume association table 2121 (FIG. 3) to select, as the output logical volume, the most suitable Standby logical volume from the Standby logical volumes associated with the input Provided logical volume. The most suitable Standby logical volume is selected as the Standby logical volume with smallest data difference 3004 (FIG. 3). It is because the smallest data difference suggests the lowest time to synch, when the processing reaches 7006. Other parameters may be taken into account such as the type of disk devices 2213 (e.g. SATA, SSD), the topology, for example to avoid current bottlenecks of the computer system 100, and the presence or absence of other Standby logical volumes associated with the same Provided logical volume in the same storage apparatus 2200.

In 7003, the Logical volume provision program 2125 refers to the Storage management table 2124 (FIG. 6) to determine whether a new logical volume can be provided with the size of the input Provided logical volume. A new logical volume can be provided if the required size can be reached with free space 6002 (FIG. 6), Free logical volumes that are Formatted 6003 (FIG. 6), or the combination of both, from one of the storage apparatuses 2200. If the system is set a policy to preferentially select a Formatted volume over the free space 6002, the system can save the time for formatting new volume, When a new logical volume can be provided (Yes in 7003), the processing goes to 7005. When a new logical volume cannot be provided (Yes in 7003), the processing goes to 7004.

In 7004, the Logical volume provision program 2125 refers to the Logical volume association table 2121 (FIG. 3) to select the Standby logical volume most suitable to be deleted, i.e. made free space, or formatted. As explained before, the Standby logical volume is managed to be the standby of the currently used volume, on the other hand, the Standby logical volume itself is not used by the host. Therefore, in lack of free space, the standby volume can be used to satisfy the new resource requirement from the host. The criteria to select the most suitable Standby logical volume is, for example, with the biggest data difference 3004 (FIG. 3), and/or with the important flag 3005 (FIG. 3). Considering that a portion or the whole selected logical volume will be provided, other parameters may be taken into account such as the capacity of the logical volume, the type of disk devices 2213 (e.g. SATA, SSD), the topology, and the current bottlenecks of the computer system 100. Once a Standby logical volume is selected, it is either formatted or made free space, and therefore the capacity values in the Storage management table 2124 (FIG. 6) change. Then, the processing goes back to 7003 to determine again whether the free space or the Formatted logical volumes are enough. An error with the message “not enough space” is thrown, for example to the administrator of the system 100 through the output 2113 of the management computer 2100, when there is no enough free space to provide a new logical volume with the size of the input Provided logical volume, and there are no Standby logical volumes, i.e. the Logical volume association table has no rows.

In 7005, the Logical volume provision program 2125 refers to the Storage management table 2124 (FIG. 6) and the Logical volume management table 2123 (FIG. 5) to select, as the output logical volume, a logical volume by creating a new logical volume from free space 6002 (FIG. 6) or selecting a Formatted logical volume 6003 (FIG. 6), with the required size. A Formatted logical volume may be deleted, i.e. made free space, in order to create a new logical volume with the required size. After the output logical volume is selected, the whole input Provided logical volume is copied to the output logical volume.

In 7006, the Logical volume provision program 2125 refers to the Logical volume association table 2121 (FIG. 3) and to the information pointed by the data difference 3004 (FIG. 3) to synch the input Provided logical volume and the output Standby logical volume selected in 7002, by copying the data difference from the input Provided logical volume to the selected Standby logical volume. A situation where both logical volumes are already synched, and therefore no copy is needed may occur. Based on the current state of the storage system, and the current amount of data difference 3003 of the Standby logical volume, if it is determined that the synch is going to take longer time than a full copy, a full copy is done instead of a synch.

In 7007, the Logical volume provision program 2125 removes, from the Logical volume association table 2121 (FIG. 3), the row corresponding to the output Standby logical volume selected in 7002.

In 7008, the Logical volume provision program 2125 adds, to the Logical volume pairing table 2122 (FIG. 4), a new row that represents a pair relation where the input Provided logical volume becomes Primary logical volume and the logical volume selected as output logical volume in 7002 or 7005 becomes Secondary logical volume.

The usual situation when performing scale out is to kept both logical volumes synched, and the usual situation when performing migration is to change the roles of the pair relation and then delete the input logical volume before the data in the logical volumes is modified. In the unusual situation when the two logical volumes are not kept synched, the pairing relation is cancelled.

In the situation when the input logical volume is already a Secondary logical volume paired with a Primary logical volume V in the Logical volume pairing table 2122 (FIG. 4), the new row added represents a pair relation where the logical volume V becomes Primary logical volume and the output logical volume becomes Secondary logical volume. This is because a Provided logical volume cannot be Primary and Secondary at the same time, in order to ensure that a set of paired logical volumes with the same data are paired the same Primary logical volume, and therefore make easy the management of their Standby logical volumes.

In 7009, the Logical volume provision program 2125 provides the output logical volume to a new host computer (or the same host computer already recognizing the input logical volume) as follows: (1) changing the state of the output logical volume to Provided in the Logical volume management table 2123 (FIG. 5), (2) updating the storage space in the Storage management table 2124 (FIG. 6), and (3) sending requests to the corresponding disk controller 2211 and to other resources of the storage apparatus 2200 and to the new host computer 2000 in order to configure the I/O path and ensure that the new host reaches the logical volume (e.g. assign ports, configure permissions).

A synch function according to the pairing relation is requested to the disk controller 2211 in the storage apparatus 2200 where the Primary logical volume or the Secondary logical volume belongs. The synch function can be configured in other resource.

Further, the subprocess composed by 7003 and 7004 is used when requesting a logical volume provision that is not a copy of other logical volume. In this case, whether the requested amount of space is available or not is determined in step 7003.

Further, when the computer system 100 or each storage apparatus 2200 keeps a predefined percentage of Formatted logical volumes from the total storage capacity, the subprocesses of 7003 and 7004 are used. In this case, whether the predetermined percentage of Formatted logical volumes exist is determined in 7003, and if not, 7004 is executed. With this process, the system can avoid the wait for the format process.

<Logical Volume Deletion Processing>

FIG. 8 is a flowchart for explaining processing to answer a request of deletion of a Provided logical volume that has a pairing relation, for example, for the purpose of performing auto-scale (reduce resources) or migration (delete original logical volume after copy). The request may be received from an administrator via the input device 2111. The processing receives as input the logical volume to be deleted. The processing is started by an automated process when a condition is reached (e.g. auto-scale). The processing can also be started by an end-user through a provisioning service or an administrator through the management computer.

In 8001, the Logical volume deletion program 2126 refers to the Logical volume pairing table 2122 (FIG. 4) to determine if the input logical volume is suitable to become Standby logical volume. It is because if all deleted logical volumes become Standby, a storage apparatus 2200 may run out of free space and Formatted logical volumes, triggering a deletion of Standby logical volumes to obtain free space. As a result, Standby logical volumes that may be useful in the future are deleted and cannot be used in the future. To avoid that, only the paired logical volumes to be deleted that are expected to be useful are kept.

A paired logical volume is suitable to become Standby if the corresponding logical volume read write rate 4003 (FIG. 4) is above a predefined threshold. The higher rate value is, the more read I/Os and less write I/Os has the logical volume, and changes in the data in the logical volume are fewer. Therefore, a logical volume is more suitable to become Standby. The threshold can be predefined by the admin for each storage apparatus 2200 or for all of them. The suitability can be also determined based in other parameters such as the recent rate of data change of the logical volume, which can be inferred from the logical volume cache, the number of previous scale out operations, and the current amount of free space.

When the input logical volume is suitable (Yes in 8001), the processing goes to 8002. When the input logical volume is not suitable (No in 8001), the processing goes to 8003.

In 8002, the Logical volume deletion program 2126 releases resources and updates the tables of the management computer as follows: (1) sending a request to release the host computer where the input logical volume was provided, and the resources that made possible the coupling between the host computer and the logical volume (e.g. storage port, switch), (2) changing the state of the input logical volume to Standby in the Logical volume management table 2123 (FIG. 5), (3) updating the Storage management table 2124 (FIG. 6), (4) removing the rows in the Logical volume pairing table 2122 (FIG. 4) where the input logical volume appears, (5) sending a request to the disk controller 2211 to keep track of the data that becomes different between input logical volume and the Provided logical volume (the track of the data that becomes different can be stored elsewhere), and (6) creating a new row in the Logical volume association table 2121 (FIG. 3) with the association between the input logical volume 3002 and the Provided logical volume 3001 that was Primary logical volume in a pairing relation with the input logical volume, and the pointer 3004 to the location where the disk controller 2211 stores the track of the data that becomes different.

In 8003, the Logical volume deletion program 2126 requests the storage apparatus to delete, i.e. make free space, or format, i.e. become Formatted, the input logical volume. The processing updates the Logical volume management table 2123 (FIG. 5) and the Storage management table 2124 (FIG. 6).

<Difference Update Processing>

FIG. 9 is a flowchart for explaining processing to keep updated the association between Standby logical volumes and Provided logical volumes. The processing is executed in the background in short time intervals. The processing can also be executed when a data change event is received. The processing can be done by a single process, or by multiple independent processes for each storage apparatus 2200, or for each management computer 2100.

In 9001, the Difference update program 2127 refers to the Logical volume association table 2121 (FIG. 3) to retrieve all the Standby logical volumes. For example, if the processing is done for each storage apparatus 2200, the Standby logical volumes of the storage apparatus 2200 are retrieved.

In 9002, the Difference update program 2127 iterates each of the Standby logical volumes retrieved in 9001. Hereinafter, the Standby logical volume selected for the each iteration is referred as iterated logical volume.

In 9003, the Difference update program 2127 refers to the Logical volume association table 2121 (FIG. 3) to retrieve the logical volume associated with the iterated logical volume in 9002, and refers to the Logical volume management table 2123 (FIG. 5) to determine whether or not the retrieved associated logical volume is Provided. When the associated logical volume is Provided (Yes in 9003), the processing goes to 9005. When the associated logical volume is not Provided (No in 9003), i.e. it is Formatted, it is on standby or it does not appear in the Logical volume management table 2123, the processing goes to 9004. The capacity of the logical volume associated and the iterated logical volume can be compared by referring to the Logical volume management table 2123 (FIG. 5). In the case where the capacity has become different, cause for example by volume scale up or scale down, an option is that the processing goes to 9004 and the iterated logical volume is deleted. An alternative is to resize the iterated logical volume to match the capacity and then the processing goes to 9005 to update the data difference.

In 9004, the Difference update program 2127 orders the storage apparatus to delete, i.e. make free space, or format, i.e. become Formatted, the iterated logical volume in 9002. The processing updates the Logical volume management table 2123 (FIG. 5) and the Storage management table 2124 (FIG. 6).

In 9005, the Difference update program 2127 refers to the Logical volume association table 2121 (FIG. 3) to retrieve the pointer 3004 to the data difference between the iterated logical volume and its associated logical volume, computes the current amount of data difference, and updates the corresponding amount of data difference 3003 in the Logical volume association table 2121.

In 9006, the Difference update program 2127 refers to the Logical volume association table 2121 (FIG. 3) to determine whether or not the iterated logical volume in 9002 needs to be synched. In this embodiment a logical volume needs to be synched when its important 3005 is “YES”, and the amount of data difference 3003 has reached or surpassed the data difference threshold 3006. Or it is possible to make all logical volumes target of synchronized process without managing the importance of them, When the logical volume needs to be synched (Yes in 9006), the processing goes to 9007. When the logical volume does not need to be synched (No in 9006), the processing continues the iteration in 9002 to check the next Standby logical volume.

In 9007, the Difference update program 2127 refers to the information pointed by the data difference value in 3004 in the Logical volume association table 2121 (FIG. 3), in order to synch at least beyond the data difference threshold 3006. As one example, to what extent the iterated logical volume is synchronized with its associated logical volume can depend on computer system 100 workload. That means that if workload is higher than a predetermined value, a logical volume is synched only partially. And if the workload is lower than the predetermined value, it is synched fully. It is because a logical volume may have a set of files that change often and a set of files that only change sometimes. Then, it is convenient to synch only the files that change sometimes when the size of the files that change often is below the data difference threshold. Copying every time the files that change often may not be efficient. Step 9006 and 9007 are not essential to the system, However with these steps the amount of data difference 3003 is maintained as equal to or smaller than the data difference threshold 3006. Therefore, the time for preparing the volume to the host from the Standby logical volume can be kept within a desired amount of time.

As described above, according to the embodiment, the management computer 2100 takes advantage of the performed task of copying a whole logical volume into another, which is a task that consumes abundant time and resources, in order to avoid many future tasks of copying a whole logical volume. The embodiment can be implemented as a management processing transparent for administrators.

Therefore, by allowing management operations such as scale out and migration to be performed avoiding a full logical volume copy, (1) resources are efficiently used and (2) unexpected problems and demands can be satisfied in short time before downtime and bad performance occur.

While an embodiment has been described above, it should be understood that the present invention is not limited to the embodiment described above, and may be changed variously without departing from the scope and spirit of the present invention.

### REFERENCE SIGNS LIST

100 Computer system
2000 Host computer
2100 Management computer
2200 Storage apparatus
2212 Logical volume

1. A management system comprising:
an interface unit coupled to a storage system and a host system of the storage system; and
a processor unit coupled to the interface unit and configured to manage a plurality of logical volumes,
wherein the plurality of logical volumes includes a first logical volume provided to the host system and a second logical volume, and
wherein the processor unit is configured to, based on the information,
manage the second logical volume as a duplicate volume of the first logical volume and a first state volume which is a logical volume provided to the host system,
change the second logical volume to a second state volume associated with the first logical volume, which is not a logical volume provided to the host system and which is on standby for a future use by the host system, and
manage a data difference between data stored in the second logical volume which is the second state volume and data stored in the first logical volume associated with the second logical volume if data is newly stored in the first logical volume.

2. The management system according to claim 1,
wherein the processor unit is configured to, in response to a request to duplicate the first logical volume, provide the second logical volume to the host system, if managed second state volumes include the second logical volume associated with the first logical volume.

3. The management system according to claim 2,
wherein the processor unit is configured to provide a third state volume to the host system, if the managed second state volumes don't include the second logical volume associated with the first logical volume, and
wherein the third state volume is not a logical volume provided to the host system but a logical volume formatted.

4. The management system according to claim 2,
wherein the processor unit is configure to store the data difference in the second logical volume associated with the first logical volume before providing the second logical volume to the host system, if there is the data difference.

5. The management system according to claim 2,
if there are two or more second state volumes associated with the first logical volume, the second logical volume is the second state volume whose data difference is the smallest in the two or more second logical volumes.

6. The management system according to claim 1,
wherein the processor unit is configured to change the second logical volume to a third state logical volume when the first logical volume is not associated with the second logical volume, and
wherein the third state volume is not a logical volume provided to the host system but a logical volume formatted.

7. The management system according to claim 1,
wherein the processor unit is configured to, when amount of the data difference is above a threshold, fully or partially store the data difference in the second logical volume which is the second state volume and associated with the first logical volume.

8. The management system according to claim 2,
wherein the processor unit is configured to, in response to a request to migrate the first logical volume associated with the second logical volume, provide the second logical volume to the host system.

9. The management system according to claim 1,
wherein the processor unit is configured to, in response to delete the duplicate volume, change the second logical volume to the second state volume.

10. The management system according to claim 1,
wherein the processor unit is configured to determine to manage the second logical volume as the second state volume if the read I/O rate among the I/Os of the first logical volume is above a predefined threshold.

11. The management system according to claim 10,
wherein the processor unit is configured to determine to manage the second logical volume as a third state volume if the read I/O rate among the I/Os of the first logical volume is equal to or less than a predefined threshold.
wherein the third state volume is not a logical volume provided to the host system but a logical volume formatted.

12. A storage system coupled to a host system, comprising:
a plurality of storage devices which is a basis of logical volume included in a plurality of logical volumes; and
a controller unit coupled to the plurality of storage devices and the host system,
wherein the plurality of logical volumes includes a first logical volume provided to the host system and a second logical volume, and
wherein the controller unit is configured to
control the second logical volume to be a duplicate volume of the first logical volume and provide the second logical volume to the host system,
stop controlling the second logical volume to be a duplicate volume of the first logical volume and providing the second logical volume to the host system,
associate the second logical volume with the first logical volume so that the second logical volume is on standby for a future use by the host system,
manage a data difference between data stored in the second logical volume which is the second state volume and data stored in the first logical volume associated with the second logical volume if data is newly stored in the first logical volume by the host system.

13. A method for managing a plurality of logical volumes in a storage system coupled to a host system, including a first logical volume provided to the host system and a second logical volume, the method comprising:
managing the second logical volume as a duplicate volume of the first logical volume and a first state volume which is a logical volume provided to the host system,
changing the second logical volume to a second state volume associated with the first logical volume, which is not a logical volume provided to the host system and which is on standby for a future use by the host system,
managing a data difference between data stored in the second logical volume which is the second state volume and data stored in the first logical volume associated with the second logical volume if data is newly stored in the first logical volume.
